(19) United States
(12) Patent Application Publication
(10) Pub. No.: US 2019/0064517 A1
(43) Pub. Date: Feb. 28, 2019

(54) Head Up Display Dynamic And Static Distortion Measurement And Specification Using Programmable And Automated XYZLDA Positioning System And Still/Video Camera

(71) Applicant: Panasonic Automotive Systems Company of America, Division of Panasonic Corporation of North America, Peachtree City, GA (US)

(72) Inventors: GERALD TANG-KONG, NEWNAN, GA (US); TOM BURNS, ATLANTA, GA (US)

(21) Appl. No.: 16/116,555

(22) Filed: Aug. 29, 2018

Related U.S. Application Data
(60) Provisional application No. 62/552,808, filed on Aug. 31, 2017.

(51) Int. Cl. G02B 27/01; G01M 11/02; G02B 5/30

(52) U.S. Cl. CPC G02B 27/0101; G02B 2027/0141; G02B 5/30; G01M 11/02

(57) ABSTRACT

A head up display testing arrangement includes an optical instrument detecting an optical quality of a light field produced by a head up display projector. A rotatable support device is attached to and supports the optical instrument. A three-dimensional positioning assembly is attached to and supports the tiltable support device. The three-dimensional positioning assembly includes an x-axis linear drive module, a y-axis linear drive module, and a z-axis linear drive module. Each one of the x-axis linear drive module, the y-axis linear drive module, and the z-axis linear drive module translates the tiltable support device in a direction orthogonal to directions in which other two of the x-axis linear drive module, the y-axis linear drive module, and the z-axis linear drive module translate the rotatable support device. A rollable cart is attached to and supports the three-dimensional positioning assembly.

### CROSS-REFERENCE TO RELATED APPLICATIONS

This application claims the benefit of U.S. Provisional Application No. 62/552,808 filed on Aug. 31, 2017, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

A Head Up Display is an optical system and as such produces static and dynamic distortions of the virtual image. Static distortions of the virtual image in a HUD have been identified, quantified and can be measured. As such, the original equipment manufacturers (OEMs) have set specification limits and tolerances using a test grid and comparison of the projected virtual image against the standard test image grid when viewed from a stationary eye point within the eye box.

Dynamic distortion occurs when the virtual image changes as the viewer's eye moves continuously within the eye box. This dynamic distortion is a continuous distortion of the virtual image during this movement within the eye box. Definition and specification of dynamic distortion have not been fully characterized by OEMs or suppliers. Presently, there is no procedure for measuring or specifying dynamic distortion as there is for static distortion.

### SUMMARY

The present invention may enable the measurement of dynamic distortion in a HUD and subsequently leads to the specification of dynamic distortion. The present invention may be used in the process of designing a HUD by placing the designated vehicle windshield on an optical table and measuring the characteristics of the HUD image such as brightness level, brightness uniformity, contrast ratio, polarization, static and dynamic distortion at various locations within three-dimensional space. The various locations within three-dimensional space may represent various possible locations of a user's eye within the eye box.

The present invention may provide test equipment including precision linear motorized stages that traverse a platform simultaneously or singularly in X, Y and Z directions. This platform incorporates a tilt feature which accommodates look down angles. The Y-axis is left/right, the X-axis is front/rear, and the Z-axis is down/up. Equipment such as a still/video camera, photoradiometer or other similar equipment can be mounted on the XYZLDA positioner mounting platform. That is, the camera, photoradiometer or other optical instrument may be positioned using a motorized XYZLDA (XYZ look down angle) positioning system. The look down angle is the angle between the horizontal axis and the direction from the driver's eye to the virtual image which is located at the front of the vehicle. The virtual image may be located below the horizontal axis.

Motion in the X-axis accurately locates image recording equipment in front/rear eye box location. Motion in the Y-axis and the Z-axis results in image recording equipment traversing horizontally, vertically or diagonally within the eye box at any specified vertical or horizontal location. This traverse can be continuous where speed of traverse can be specified or incremental where incremental steps and duration are specified. The virtual image can be recorded during traverse showing dynamic distortion using a video camera. Images can also be individually recorded at each incremental step using a camera. This allows recording of the virtual image under all conditions enabling accurate definition of distortions by comparing these distorted images with original undistorted image. This data allows analyses and extraction of the distortions and subsequent distortion correction implementation.

In one embodiment, the invention comprises a head up display testing arrangement including an optical instrument detecting an optical quality of a light field produced by a head up display projector. A tiltable support supports the optical instrument. A three-dimensional positioning assembly is attached to and supports the tiltable support. The three-dimensional positioning assembly includes an x-axis linear drive module, a y-axis linear drive module, a z-axis linear drive module, and a rotary drive module to tilt the support. Each one of the x-axis linear drive module, the y-axis linear drive module, and the z-axis linear drive module translates the optical instrument support device in a direction orthogonal to directions in which other two of the x-axis linear drive module, the y-axis linear drive module, and the z-axis linear drive module translate the tiltable support device. A rollable cart is attached to and supports the three-dimensional positioning assembly.

In another embodiment, the invention comprises a head up display testing method, including using an optical instrument to detect an optical quality of a light field produced by a head up display projector. A tiltable support device is attached to the optical instrument such that the tiltable support device supports the optical instrument. A three-dimensional positioning assembly is attached to the tiltable support device such that the three-dimensional positioning assembly supports the tiltable support device. The three-dimensional positioning assembly includes an x-axis linear drive module, a y-axis linear drive module, and a z-axis linear drive module and a rotary drive module. Each one of the x-axis linear drive module, the y-axis linear drive module, and the z-axis linear drive module translates the rotary drive module support device in a direction orthogonal to directions in which other two of the x-axis linear drive module, the y-axis linear drive module, and the z-axis linear drive module translate the tiltable support device. A rollable cart is attached to the three-dimensional positioning assembly such that the rollable cart supports the three-dimensional positioning assembly.

In yet another embodiment, the invention comprises a head up display testing arrangement including a head up display projector projecting a light field. A body has a reflective surface reflecting the light field. An optical instrument detects an optical quality of the reflected light field. A rotatable support device is attached to and supports the optical instrument. A three-dimensional positioning assembly is attached to and supports the rotatable support device. The three-dimensional positioning assembly positions the rotatable support device at a plurality of selected positions in three-dimensional space. A rollable cart is attached to and supports the three-dimensional positioning assembly.

### BRIEF DESCRIPTION OF THE DRAWINGS

A better understanding of the present invention will be had upon reference to the following description in conjunction with the accompanying drawings.

FIG. 1 is a perspective view of one embodiment of a head up display testing apparatus of the present invention.

FIG. 2 is a flow chart of one embodiment of a head up display testing method of the present invention.

### DETAILED DESCRIPTION OF THE PREFERRED EMBODIMENTS

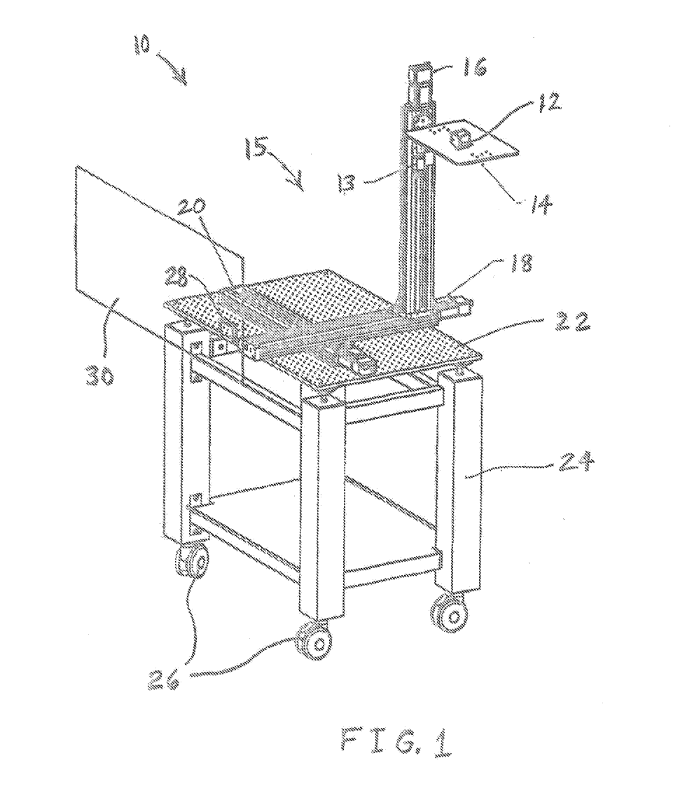

FIG. 1 illustrates one embodiment of a head up display testing apparatus 10 of the present invention, including an optical instrument in the form of a camera, photoradiometer or other optical instrument 12 mounted on a tilt platform or instrument shelf 14. Tilt platform 14 is mounted on a rotary drive module 13 which in turn is mounted on a three-dimensional positioning assembly 15 including linear drive modules 20, 16, 18 for the y-axis, z-axis, and x-axis, respectively. Y-axis linear drive module 20 is mounted to a horizontally-oriented board 22 of an optics cart 24 on wheels 26. Camera, photoradiometer or other optical instrument 12 may capture virtual images produced by a HUD projector 28 reflecting a light field off of a windshield 30. The travel distances of the X, Y, Z stages may be different from each other to accommodate the requirements of HUD measurements for field of view, eyebox size, and optical table height.

) Each one of the y-axis linear drive module 20, the z-axis linear drive module 16, and the x-axis linear drive module 18 translates the tiltable support device in a direction orthogonal to directions in which other two of the x-axis linear drive module, the y-axis linear drive module, and the z-axis linear drive module translate the rotatable support device.

Tilt platform 14 may be rotated by rotary drive motor 13 to enable the equipment to be aligned with the appropriate look down required by each HUD. Different adapter plates (not shown) may enable further expansion capabilities.

In one embodiment, the system is of medium resolution which will allow a 0.5 mm movement required by the pixel resolution at the virtual image.

The inventive system may significantly reduce set-up and measurement times with increased accuracy. Conventionally, set-up and measurements using tripods may take a couple days or more depending on the HUD and the measurements required.

The inventive system may also enable the development of a specification for dynamic distortion and a procedure for measuring such dynamic distortion. Presently, dynamic distortion is not fully specified by suppliers or OEMs. The inventive system may enable continuous recording of the virtual image as the eyepoint is moved within the eyebox, and thus affords the advantage of measuring and specifying the dynamic distortion. The inventive system may also more accurately measure static distortion, thus making it easier to meet specifications.

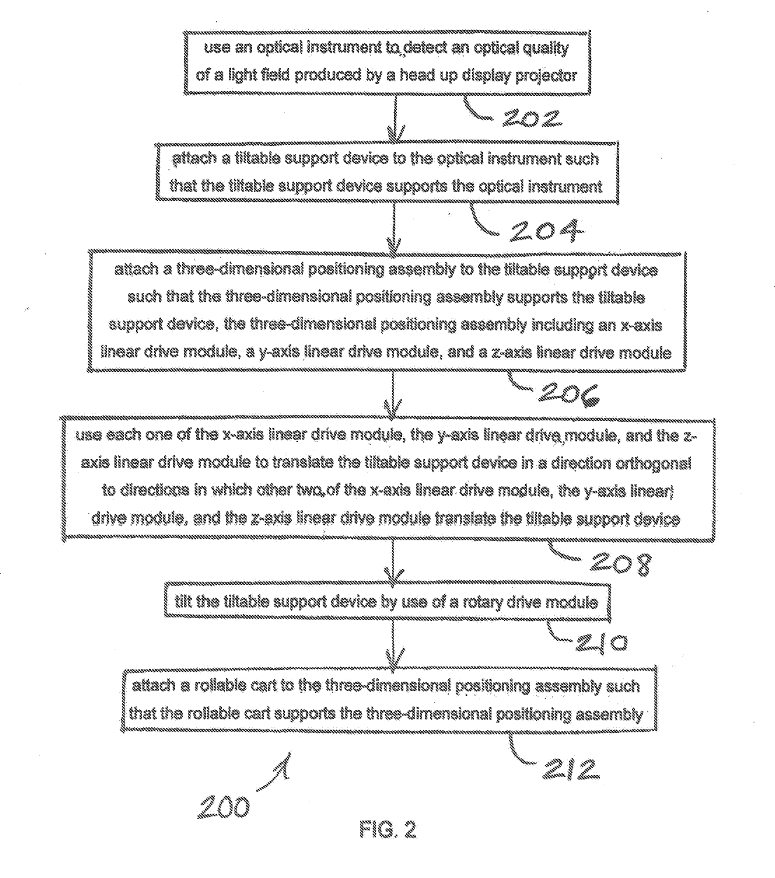

FIG. 2 illustrates one embodiment of a head up display testing method 200 of the present invention. In a first step 202, an optical instrument is used to detect an optical quality of a light field produced by a head up display projector. For example, optical instrument 12 may capture virtual images produced by a HUD projector 28 reflecting a light field off of a windshield 30. Optical instrument 12 may detect an optical quality of the light field produced by HUD projector 28.

In a next step 204, a tiltable support device is attached to the optical instrument such that the tiltable support device supports the optical instrument. For example, optical instrument 12 is mounted on and supported by tilt platform 14.

Next, in step 206, a three-dimensional positioning assembly is attached to the tiltable support device such that the three-dimensional positioning assembly supports the tiltable support device. The three-dimensional positioning assembly includes an x-axis linear drive module, a y-axis linear drive module, and a z-axis linear drive module. For example, tilt platform 14 is mounted on a rotary drive module 13 which in turn is mounted on a three-dimensional positioning assembly 15 including linear drive modules 20, 16, 18 for the y-axis, z-axis, and x-axis, respectively.

In step 208, each one of the x-axis linear drive module, the y-axis linear drive module, and the z-axis linear drive module is used to translate the tiltable support device in a direction orthogonal to directions in which other two of the x-axis linear drive module, the y-axis linear drive module, and the z-axis linear drive module translate the tiltable support device. That is, each of linear drive modules 20, 16, 18 moves tilt platform 14 in a respective direction that is orthogonal to the directions that the other two of the linear drive modules 20, 16, 18 move tilt platform 14.

In a next step 210, the tiltable support device is tilted by use of a rotary drive module. For example, tilt platform 14 may be tilted by rotary drive motor 13 to enable the equipment to be aligned with the appropriate look down required by each HUD.

In a final step 212, a rollable cart is attached to the three-dimensional positioning assembly such that the rollable cart supports the three-dimensional positioning assembly. For example, an optics cart 24 on wheels 26 is attached to three-dimensional positioning assembly 15 such that rollable cart 24 supports the three-dimensional positioning assembly 15.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display testing arrangement, comprising:
an optical instrument configured to detect an optical quality of a light field produced by a head up display projector;
a rotatable support device attached to and supporting the optical instrument;
a three-dimensional positioning assembly attached to and supporting the tiltable support device, the three-dimensional positioning assembly including:
an x-axis linear drive module;
a y-axis linear drive module; and
a z-axis linear drive module, each one of the x-axis linear drive module, the y-axis linear drive module, and the z-axis linear drive module being configured to translate the rotatable support device in a direction orthogonal to directions in which other two of the x-axis linear drive module, the y-axis linear drive module, and the z-axis linear drive module are configured to translate the rotatable support device;
a rotary drive module to tilt the support; and
a rollable cart attached to and supporting the three-dimensional positioning assembly.

2. The head up display testing arrangement of claim 1 further comprising a body having a reflective surface configured to reflect the light field produced by the head up display projector.

3. The head up display testing arrangement of claim 1 wherein the optical instrument comprises at least one of a camera and photoradiometer.

4. The head up display testing arrangement of claim 1 wherein the detected optical quality of the light field comprises a brightness level.

5. The head up display testing arrangement of claim 1 wherein the detected optical quality of the light field comprises a brightness uniformity.

6. The head up display testing arrangement of claim 1 wherein the detected optical quality of the light field comprises a contrast ratio.

7. The head up display testing arrangement of claim 1 wherein the detected optical quality of the light field comprises a polarization level.

8. The head up display testing arrangement of claim 1 wherein the detected optical quality of the light field comprises static distortion.

9. The head up display testing arrangement of claim 1 wherein the detected optical quality of the light field comprises dynamic distortion.

10. A head up display testing method, comprising:
using an optical instrument to detect an optical quality of a light field produced by a head up display projector;
attaching a tiltable support device to the optical instrument such that the tiltable support device supports the optical instrument;
attaching a three-dimensional positioning assembly to the tiltable support device such that the three-dimensional positioning assembly supports the tiltable support device, the three-dimensional positioning assembly including:
an x-axis linear drive module;
a y-axis linear drive module; and
a z-axis linear drive module;
using each one of the x-axis linear drive module, the y-axis linear drive module, and the z-axis linear drive module to translate the tiltable support device in a direction orthogonal to directions in which other two of the x-axis linear drive module, the y-axis linear drive module, and the z-axis linear drive module translate the tiltable support device;
tilting the tiltable support device by use of a rotary drive module; and
attaching a rollable cart to the three-dimensional positioning assembly such that the rollable cart supports the three-dimensional positioning assembly.

11. The method of claim 10 further comprising using a body having a reflective surface to reflect the light field produced by the head up display projector.

12. The method of claim 10 wherein the optical instrument comprises at least one of a camera and photoradiometer.

13. The method of claim 10 head up wherein the detected optical quality of the light field comprises a brightness level.

14. The method of claim 10 wherein the detected optical quality of the light field comprises a brightness uniformity.

15. The method of claim 10 wherein the detected optical quality of the light field comprises a contrast ratio.

16. The method of claim 10 wherein the detected optical quality of the light field comprises a polarization level.

17. The method of claim 10 wherein the detected optical quality of the light field comprises static distortion.

18. The method of claim 10 wherein the detected optical quality of the light field comprises dynamic distortion.

19. A head up display testing arrangement, comprising:
a head up display projector configured to project a light field;
a body having a reflective surface configured to reflect the light field;
an optical instrument configured to detect an optical quality of the reflected light field;
a rotatable support device attached to and supporting the optical instrument;
a three-dimensional positioning assembly attached to and supporting the tiltable support device, the three-dimensional positioning assembly being configured to position the rotatable support device at a plurality of selected positions in three-dimensional space; and
a rollable cart attached to and supporting the three-dimensional positioning assembly.

20. The head up display testing arrangement of claim 19 wherein the three-dimensional positioning assembly includes:
an x-axis linear drive module;
a y-axis linear drive module; and
a z-axis linear drive module, each one of the x-axis linear drive module, the y-axis linear drive module, and the z-axis linear drive module being configured to translate the rotatable support device in a direction orthogonal to directions in which other two of the x-axis linear drive module, the y-axis linear drive module, and the z-axis linear drive module are configured to translate the rotatable support device.

21. The head up display testing arrangement of claim 19 wherein the optical instrument comprises at least one of a camera and photoradiometer.

22. The head up display testing arrangement of claim 19 wherein the detected optical quality of the light field comprises a brightness level.

23. The head up display testing arrangement of claim 19 wherein the detected optical quality of the light field comprises a brightness uniformity.

24. The head up display testing arrangement of claim 19 wherein the detected optical quality of the light field comprises a contrast ratio.

25. The head up display testing arrangement of claim 19 wherein the detected optical quality of the light field comprises a polarization level.

26. The head up display testing arrangement of claim 19 wherein the detected optical quality of the light field comprises static distortion.

27. The head up display testing arrangement of claim 19 wherein the detected optical quality of the light field comprises dynamic distortion.
